(19) United States
(12) Patent Application Publication
(10) Pub. No.: US 2024/0193903 A1
(43) Pub. Date: Jun. 13, 2024

(54) Detecting Portions of Images Indicative of the Presence of an Object

(71) Applicant: Google LLC, Mountain View, CA (US)

(72) Inventors: Skirmantas Kligys, Manhattan Beach, CA (US); Wen-Sheng Chu, Santa Clara, CA (US); Xiaoming Liu, Mountain View, CA (US)

(21) Appl. No.: 18/078,634

(22) Filed: Dec. 9, 2022

(51) Int. Cl. G06V 10/25; G06T 7/13; G06V 20/70

(52) U.S. Cl. CPC G06V 10/25; G06T 7/13; G06V 20/70; G06T 2207/20016; G06T 2207/20084; G06V 2201/07

(57) ABSTRACT

Provided are systems and methods for detecting an object in an image. The method can include receiving an input image and analyzing the input image using an image segmentation model to identify one or more indicative areas within the input image, the one or more indicative areas being indicative of one or more objects within the input image. The method can also include analyzing the one or more indicative areas of the input image using a convolutional model to generate at least one label for at least one portion of the one or more indicative areas of the input image, the label indicating whether a specific object is identified within the input image, and performing at least one action based on the at least one label for the at least one portion.

### FIELD

The present disclosure relates generally to image analysis. More particularly, the present disclosure relates identifying portions of images that are indicative of particular objects being in the image, especially when said objects are not wholly contained within the image (e.g., are obstructed by another object or out of frame).

### BACKGROUND

More and more software applications are using image recognition technology, such as object identification, facial recognition, and other applications. In some instances, images can include various objects in frame or partially in frame.

Various functionality can be performed using object recognition. For example, one or more persons can be detected in an image, one or more specific objects (e.g., retail objects) can be detected, one or more animals can be detected, and the like.

When objects are not wholly within frame or are otherwise obscured in the image, however, detecting the presence of the object can be difficult. Furthermore, users want object recognition applications to be certain to a high degree that the correct object is present within the image.

### SUMMARY

Aspects and advantages of embodiments of the present disclosure will be set forth in part in the following description, or can be learned from the description, or can be learned through practice of the embodiments.

One example aspect of the present disclosure is directed to method for method for detecting an object in an image. The method can include receiving, by at least one electronic processor, an input image and analyzing, by the at least one electronic processor, the input image using an image segmentation model to identify one or more indicative areas within the input image, the one or more indicative areas being indicative of one or more objects within the input image. The method can also include analyzing, by the at least one electronic processor, the one or more indicative areas of the input image using a convolutional model to generate at least one label for at least one portion of the one or more indicative areas of the input image, the label indicating whether a specific object is identified within the input image, and performing, by the at least one electronic processor, at least one action based on the at least one label for the at least one portion.

Another example aspect of the present disclosure is directed to a computing system for detecting an object image. The computing system can include one or more electronic processors and a non-transitory, computer-readable medium comprising an image segmentation model, a convolutional model, and one or more instructions that, when executed by the one or more electronic processors, cause the one or more electronic processors to perform a process. The process can include receiving an input image and analyzing, by the at least one electronic processor, the input image using an image segmentation model to identify one or more indicative areas within the input image, the one or more indicative areas being indicative of one or more objects within the input image. The process can also include analyzing, by the one or more electronic processors, the one or more indicative areas of the input image using a convolutional model to generate at least one label for at least one portion of the one or more indicative areas of the input image, the label indicating whether a specific object is identified within the input image, and performing, by the one or more electronic processors, at least one action based on the at least one label for the at least one portion.

A further example aspect of the present disclosure is directed to a non-transitory, computer-readable medium. The non-transitory, computer-readable medium can include an image segmentation model, a convolutional model, and one or more instructions that, when executed by one or more electronic processors, cause the one or more electronic processors to perform a process. The process can include receiving an input image and analyzing the input image using an image segmentation model to identify one or more indicative areas within the input image, the one or more indicative areas being indicative of one or more objects within the input image. The process can further include analyzing the one or more indicative areas of the input image using a convolutional model to generate at least one label for at least one portion of the one or more indicative areas of the input image, the label indicating whether a specific object is identified within the input image, and performing at least one action based on the at least one label for the at least one portion.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs object recognition according to example embodiments of the present disclosure.

FIG. 1B depicts a block diagram of an example computing device that performs object recognition according to example embodiments of the present disclosure.

FIG. 1C depicts a block diagram of an example computing device that performs object recognition according to example embodiments of the present disclosure.

FIG. 2 depicts a block diagram of an example object recognition according to example embodiments of the present disclosure.

FIG. 3 depicts a block diagram of an example image segmentation model according to example embodiments of the present disclosure.

FIG. 4 depicts a block diagram of processing an input image at multiple resolution levels according to example embodiments of the present disclosure.

FIG. 5 depicts a block diagram of an image segmentation model and a convolution model being used in tandem to determine if an object is present in an image according to example embodiments of the present disclosure.

FIG. 6 depicts an input image and associated output grayscale image according to example embodiments of the present disclosure.

FIG. 7 depicts a flow chart diagram of an example method to perform object recognition according to example embodiments of the present disclosure.

Reference numerals that are repeated across plural figures are intended to identify the same features in various implementations.

### DETAILED DESCRIPTION

### Overview

Generally, the present disclosure is directed to object recognition. In particular, example aspects of the present disclosure can be used to detect an object in an image, especially when an object is partially obscured within the image. Furthermore aspects of the present disclosure can include positively identifying a particular object (e.g., a car pulling into a driveway or a person standing at a front door) while ignoring false alarms (e.g., a cat running through the driveway or a person walking on a sidewalk in view of a camera).

Images can be input into the system in a variety of ways, and the system can concentrate on particular portions of the images (“indicative areas”) to positively identify objects within an image, even when the object is blurry in an image (an object in a video frame in motion, for example), an object is partially obscured in an image, an object is only partially in frame of the image, and the like. Furthermore, indicative areas can positively identify an object (e.g., a car having two headlights, a windshield, a front bumper, and the like) to ensure that the proper object is being identified and, therefore, setting off proper notifications or alarms, instead of an improper object (e.g., a cat in the driveway) setting off a false alarm, such as indicating via a software application to a user of a mobile device that a person in at the door when, in fact, a person has only walked by on a sidewalk away from

Based on identifying these indicative areas of the image, objects in the image can be identified. Next, the identified objects can be determined to be a positive identification (e.g., an identification of a desired object, such as a person standing at a front door) or a negative identification (e.g., a person walking on the sidewalk in view of the camera but not standing at the front door). Proper response (no response, send alarm, send push notification, etc.) can then be affected based on the positive or negative identification.

To identify indicative areas, a two-stage model can be used. The first stage can predict which areas of the image are indicative areas associated with various objects in the image. The second stage can analyze the indicative area shape and other factors to predict if the object is positive for a particular object (e.g., a car or a person) or negative for the particular object.

The first stage can use an image semantic segmentation model, such as, for example, HRNet or Deeplab v3+, that is trained on labeled training images that illustrate portions of the desired objects and/or specific indicative areas of the specific objects. For example, these portions can be annotated (manually or automatically) in the labeled training images. Given a particular input image (e.g., a 512×512 input image), the first stage can produce a smaller resolution (e.g., 128×128) grayscale image showing the predicted portions of the image that are indicative of a particular object.

The second stage can be a convolutional model that receives the output of the first stage and generates a label for one or more objects in the image, such as, for example, MobileNetEdgeTPU v2. Once the first stage is trained, the second stage can be trained using various frames from real images containing or not containing various indicative areas of desired objects and/or non-desired objects. In one example, the second stage can be trained to positively identify a person standing at a front door of a residence, trained to negatively identify a person walking on the sidewalk, and/or both. Differentiation between the two can be performed, for example, by training the second stage to determine if eyes (an indicative area of being able to clearly see a face of a person) can be detected in the image, thus indicating that the person is likely at the door since the full face is visible and eyes are detectable, instead of recognizing only the silhouette of a person walking in the distance (e.g., on the sidewalk).

By implementing the present invention, various software applications that rely on object recognition can more positively identify objects in images in order to accurately trigger various actions for software systems, such as notifying a user that a person is at the front door, enabling automatic control of various objects, and the like.

With reference now to the Figures, example embodiments of the present disclosure will be discussed in further detail.

### Example Devices and Systems

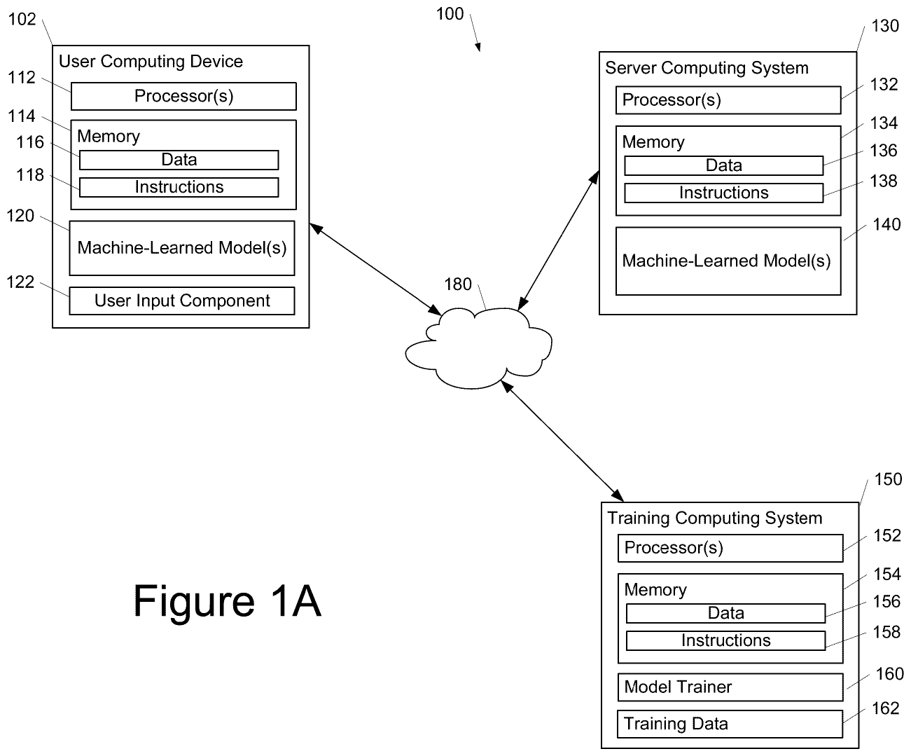

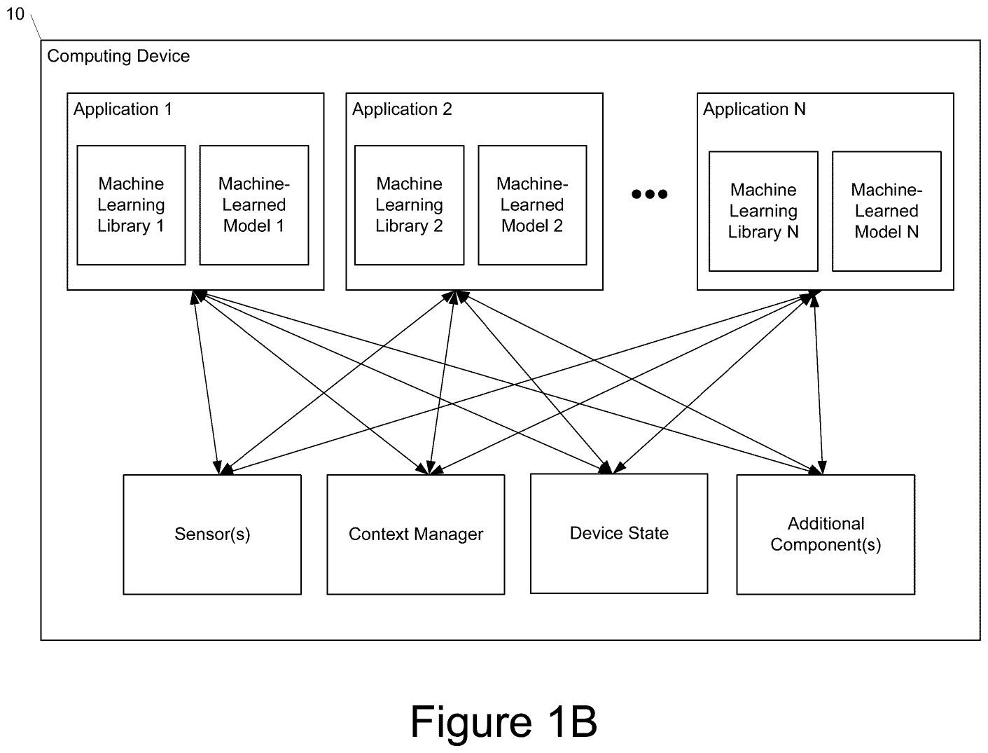

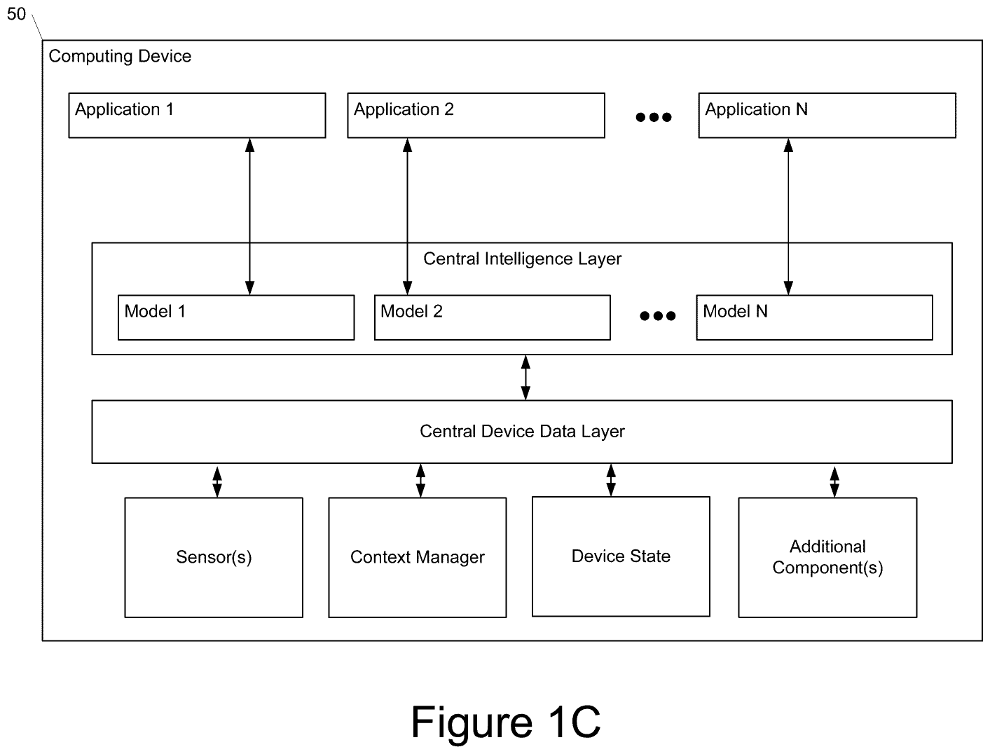

FIG. 1A depicts a block diagram of an example computing system 100 that performs object recognition according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

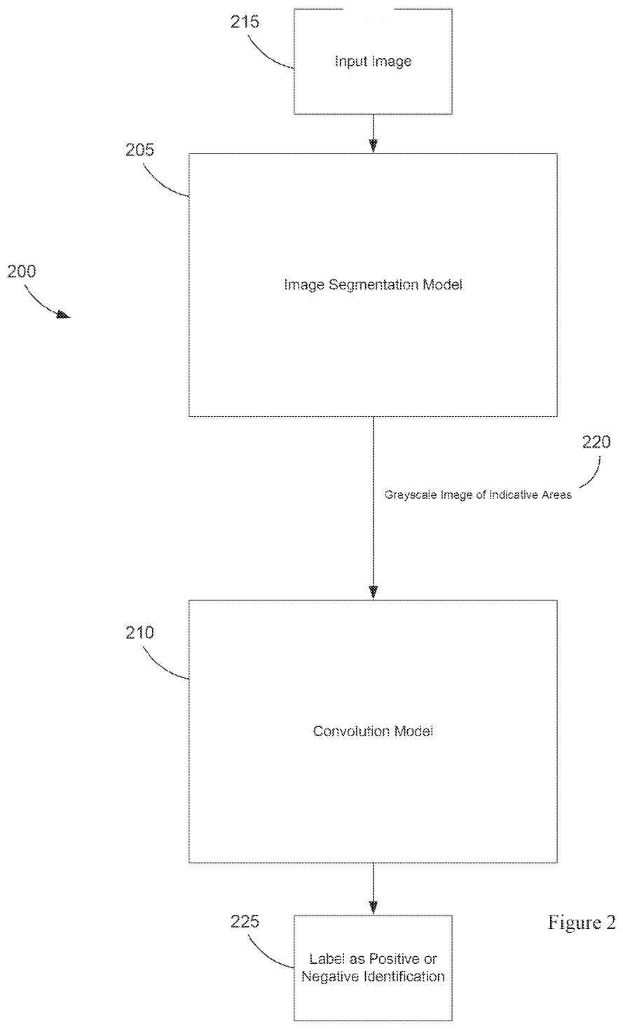

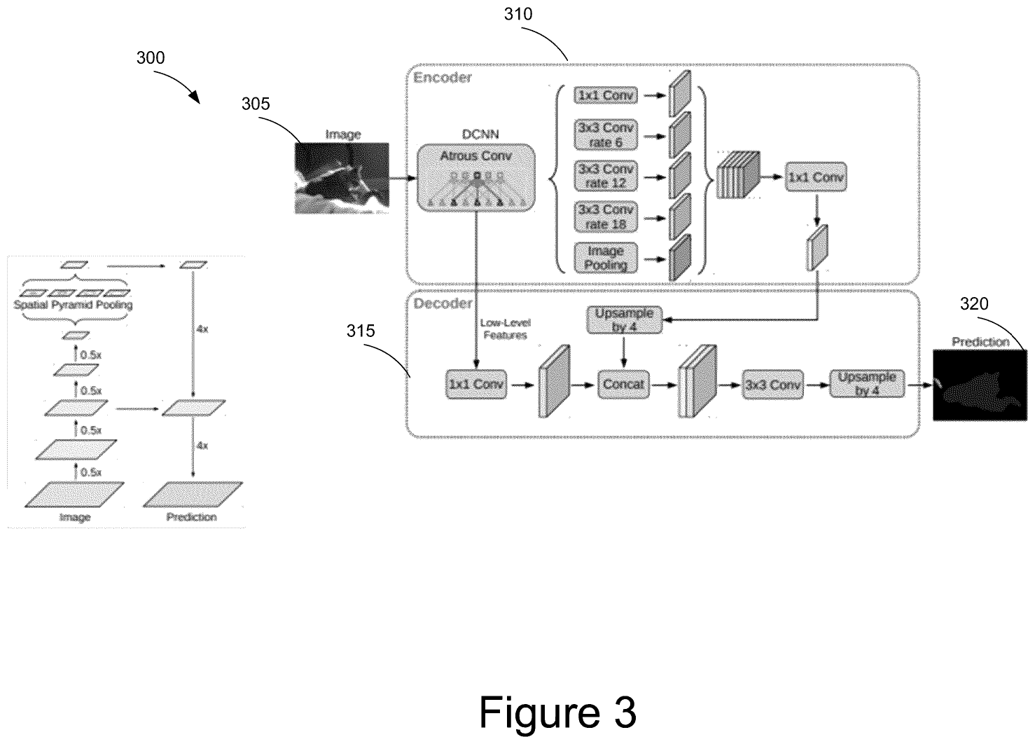

In some implementations, the user computing device 102 can store or include one or more object recognition models 120. For example, the object recognition models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example object detection models 120 are discussed with reference to FIGS. 2 and 3.

In some implementations, the one or more object recognition models 120 can be received from the server computing system 130 over network 180, stored in the user computing device memory 114, and then used or otherwise implemented by the one or more processors 112. In some implementations, the user computing device 102 can implement multiple parallel instances of a single object detection model 120 (e.g., to perform parallel object detection across multiple images).

More particularly, the object detection model 120 can identify particular objects in images. For example, the object detection model 120 can use an image semantic segmentation model and one or more convolutional models in tandem or in series to process an image and determine, based on indicative areas within the image, what objects are present in the image and if any of these objects are positive identifications that require some action after being detected (e.g., detecting a person at the front door of a home and providing an alert to a mobile device of a user who owns the home).

The object detection model 120 can include a two-stage architecture. The first stage can include a machine-learned model that can predict portions of input images that can be indicative areas of particular objects. This machine-learned model can be, for example, an image semantic segmentation model. Example models can include HRNet and Deeplab v3+.

In general, the image semantic segmentation model can receive an input image of a certain resolution (e.g., 512×512 pixels) and output a grayscale image at a lower resolution (e.g., 128×128). This output grayscale image highlights portions of the input image that can be considered to be indicative of particular objects.

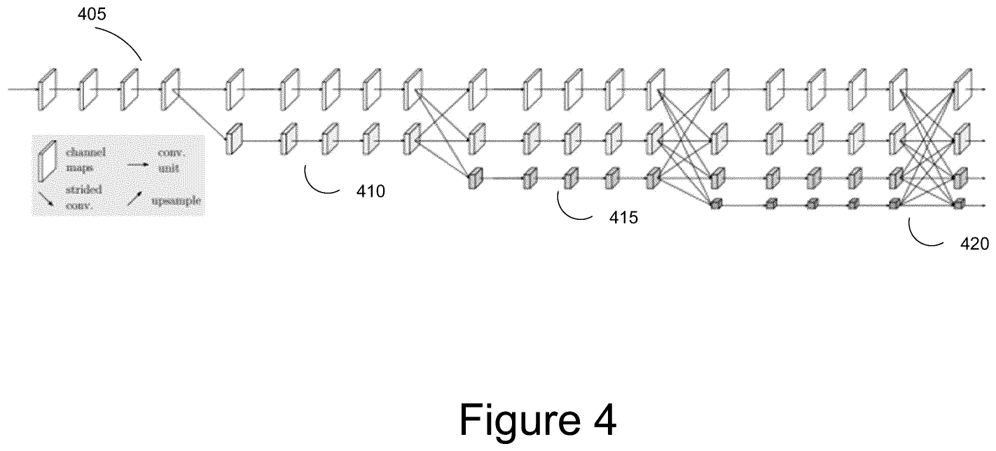

In some embodiments, the image segmentation model can perform processing in parallel at multiple resolution levels. Additional details can be found below with regards to FIG. 4.

In some embodiments, the image segmentation model can use an encoder-decoder structure. Additional details can be found below with regards to FIG. 3.

The second stage can include a convolutional neural network model (“convolutional model”) that takes as input the grayscale image output of the image segmentation model as an input and generates a positive identification (e.g., an object in the image is an object being sought, such as a person at a front door) or a negative identification (e.g., an object in the image is not an object being sought), such as MobileNetEdgeTPU v2. This model can include one or more convolution layers, one or more pooling layers, and a fully-connected layer. Earlier layers can focus on simple features, while later layers can identify more complex features until the convolution model identifies the intended object.

Additionally or alternatively, one or more object detection models 140 can be included in or otherwise stored and implemented by the server computing system 130 that communicates with the user computing device 102 according to a client-server relationship. For example, the object detection models 140 can be implemented by the server computing system 130 as a portion of a web service (e.g., an object detection service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more object detection models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 2 and 3.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the object detection models 120 and/or 140 based on a set of training data 162. The training data 162 can include, for example, two different sets of training data. For an image segmentation model, the training data can include labeled and annotated images. For example, an image may be labeled “positive identification” and include annotations such as “eyes visible on front of face,” “two car headlights present in zone defined by driveway,” and/or “logo detected on front of shirt.” In some embodiments, the training images can also include confidence scores indicating how confident a model should be that different indicative areas of objects are present. Confidence scores can be given using a rating system, such as a percentage system (e.g., 95% confidence that the indicative area indicates that the object is present), a numerical system (e.g., 5 being the most confident that the indicative area indicates that the object is present), and the like.

The second set of training data can be used to train the convolution model. This set of training data can include frames from collections of videos or images that illustrate images that include positive identifications of particular objects or negative identifications of particular objects or both. In some embodiments, the second set of training data can also include grayscale images (such as the grayscale image output by the image segmentation model) that are labeled as positive or negative identifications of particular objects. In some embodiments, these grayscale images can also include further annotations such as “human at front door” and the like.

In some embodiments, the training data can be labeled by humans using a software tool. Humans can label regions in images that are “indicative areas” or that indicate that the region is important for positive or negative identification of a particular object. This can be performed at, for example, a pixel level, and the label can be a binary score (“yes” or “no” for the pixel being part of an indicative area) or ranked using a scoring or categorical system (e.g., labeling pixels using a discrete system “0,” “1,” “2,” “3,” etc. indicating how likely it is that the pixel is part of an indicative area) or a continuous score (e.g., on a scale of 0-3) and the like.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs object detection according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs object detection according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a block diagram of an example object detection model 200 according to example embodiments of the present disclosure.

The object detection model 200 can include an image segmentation model 205 and a convolution model 210. The image segmentation model 205 can receive as input an input image 215. The image segmentation model 205 performs various image segmentation techniques to identify portions of the input image 215 that can be indicative of the input image 215 including one or more specific objects. Identified portions of the input image 215 are then transformed into a lower resolution grayscale image 220 that highlight the identified portions. This grayscale image 220 is then output from the image segmentation model 205 and sent to the convolution model 210. The convolution model 210 analyzes the grayscale image 220 to determine if the highlighted portions in the grayscale image 220 indicate that the input image 215 does, in fact, include one or more specific objects. The convolution model 210 then outputs a label 225 based on this analysis. Label 225 labels the input image 215 as containing the one or more specific objects (positive identification) or not containing the one or more specific objects.

FIG. 3 depicts a block diagram of an example image segmentation model 300 according to example embodiments of the present disclosure. The image segmentation model 300 can receive an input image 305. The input image 305 can be received by an encoder 310, which can convert the input image 305 input a plurality of vectors using various machine-learning techniques, such as convolution networks, recurrent neural networks, and the like. The encoder 310 can employ multi-scale contextual information by applying, for example, atrous convolution at multiple scales. The vectors can, in some embodiments, be descriptive of segmentation of the image into various portions. These vectors can then be passed to decoder 315, which can convert the plurality of vectors into an output. This can be performed using various machine-learning techniques, such as convolution networks, recurrent neural networks, upsampling, pooling layers, and the like. In some embodiments, the decoder 315 can refine the segmentation results along object boundaries. The decoder 315 then outputs a prediction grayscale image 320 with objects in the prediction grayscale image 320 highlighted against the rest of the image. In some embodiments, these highlighted objects include portions of the image that are indicative areas of the image for one or more specific objects.

In some embodiments, the image segmentation model 300 can receive input image 305 at a particular resolution (e.g., 512×512) and output the prediction grayscale image 320 at a lower resolution (e.g., 128×128), as the prediction grayscale image 320 does not need to maintain the same resolution of features in the input image 305, but rather only define the portions of the input image 305 that can be indicative of the input image 320 including the one or more specific objects.

In some embodiments, the image segmentation model 300 can be a high-resolution network that processes the input image 305 in parallel at multiple resolution levels. For example, FIG. 4 illustrates such processing. First resolution level 405 can include one or more high-resolution convolutions. Second resolution level 410, third resolution level 415, and fourth resolution level 420 can repeat two-resolution, three-resolution, and four-resolution blocks that take the output of other resolution levels and performs convolution on the combination of the inputs. In these embodiments, the final output of each level can be upsampled and concatenated or aggregated into a single set of features. This single set of features can then be processed by the image segmentation model 300 to perform semantic segmentation and output the prediction grayscale image 320.

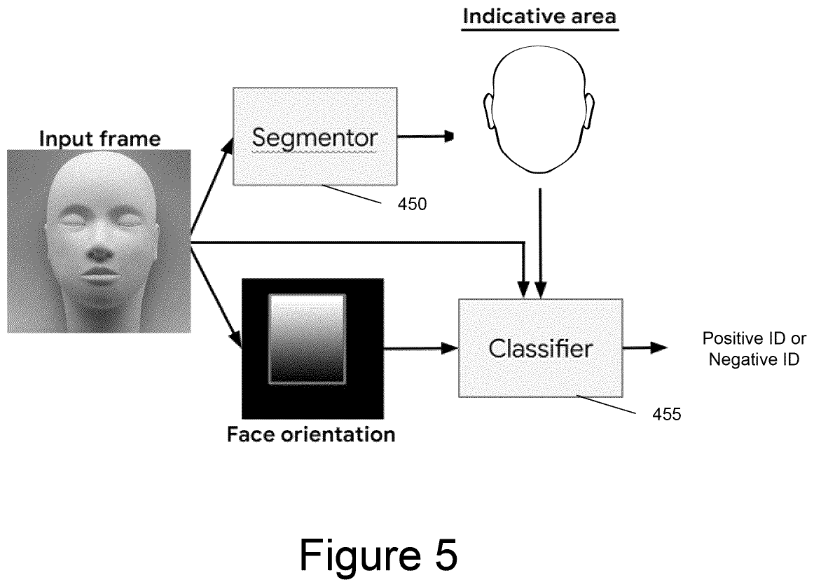

FIG. 5 depicts a block diagram of an image segmentation model 450 and a convolution model 455 being used in tandem to determine if an image includes one or more specific objects according to example embodiments of the present disclosure.

In some implementations, the object detection system can further include a face orientation or location detector that processes the input frame to generate an indication of the orientation or location of the face within the input image. The indication of the orientation or location of the face within the input image can also be provided as an input to the classifier alongside the greyscale image. In some implementations, the indication of the orientation or location of the face within the input image can be represented as a bounding box and/or a gradient indicating the location and/or orientation of the face.

The image segmentation model 450 can receive the input frame and output an indicative area. This indicative area can be provided to the convolution model 455. Additionally, an orientation of the face from the input frame can be provided to the convolution model 455 as an additional input. These two inputs can be processed by the convolution model to determine if the input frame is indicative of a particular object being present in the image, such as a clear outline of a human face.

### Example Images

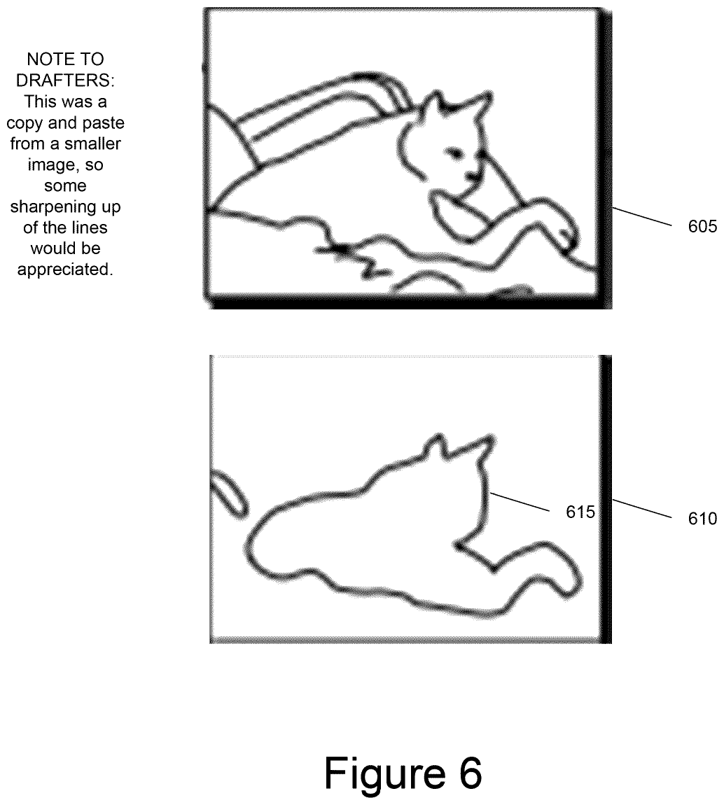

FIG. 6 depicts an input image 605 and associated output grayscale image 610 according to example embodiments of the present disclosure. In the given example, the input image 605 can depict an object to be positively identified (for example, a cat). The input image 605 can be processed to create the output grayscale image 610. The output grayscale image 610 can include, for example, an area defined by an outline 615 that is shaded differently than the remainder of the image. The area defined by outline 615 can be, for example, an indicative area of a specific object to be identified.

### Example Methods

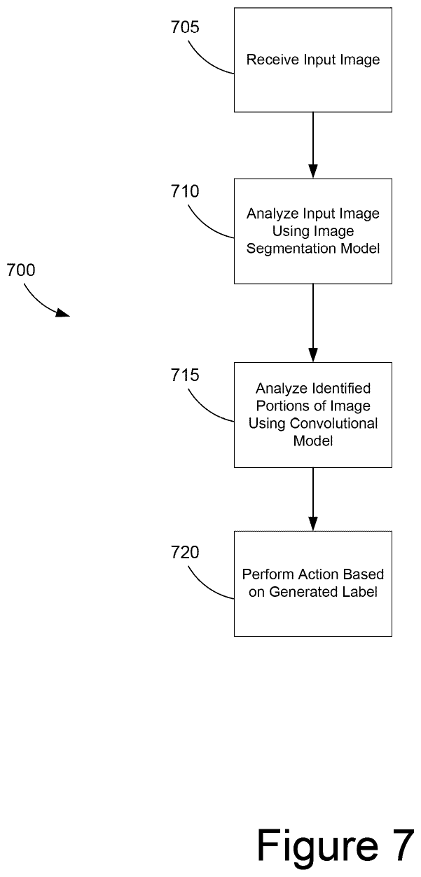

FIG. 7 depicts a flow chart diagram of an example method 700 to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 705, a computing system receives an input image. In some embodiments, the input image can be a 512×512 input image received for the purposes of identifying an object and performing a specific action associated with positive identification of a specific object within in image.

At 710, the computing system analyzes the input image using an image segmentation model to generate an output. As described above, the image segmentation model can receive the image and perform various image segmentation techniques to identity objects, users, and portions of the image indicative of the image containing a specific object. For example, the image segmentation model can identify eyes on faces, paws or tails of pets, headlights of cars in driveways, logos on clothing, and the like.

At 715, the computing system analyzes the output grayscale image using a convolution model. The convolution model receives the grayscale image and processes the grayscale image to determine if the identified portions indicative of specific objects are, in fact, indicative of an object for positive identification (e.g., human is standing at front door). Based on the analysis of the grayscale image, the convolution model outputs a label indicating if the image has an object with a positive identification (specific object is the object attempting to be detected) or an object with a negative identification (specific object is not the object attempting to be detected). In some embodiments, the convolution model can also output a confidence score indicating how confident the convolution model is that the detected object should be positively identified.

At 720, the computing system can perform an action based on the generated label. For example, if the image is positively identified as a person

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A method for detecting an object in an image, the method comprising:
receiving, by at least one electronic processor, an input image;
analyzing, by the at least one electronic processor, the input image using an image segmentation model to identify one or more indicative areas within the input image, the one or more indicative areas being indicative of one or more objects within the input image;
analyzing, by the at least one electronic processor, the one or more indicative areas of the input image using a convolutional model to generate at least one label for at least one portion of the one or more indicative areas of the input image, the label indicating whether a specific object is identified within the input image; and
performing, by the at least one electronic processor, at least one action based on the at least one label for the at least one portion.

2. The method of claim 1, wherein the one or more indicative areas of the input image are represented by a grayscale image illustrating the one or more indicative areas in the input image.

3. The method of claim 2, wherein the output of the image segmentation model is the grayscale image.

4. The method of claim 1, wherein the image segmentation model processes the input image at multiple resolution levels to identify the one or more indicative areas of the input image.

5. The method of claim 4, wherein outputs of the multiple resolution levels are aggregated by the image segmentation model to perform semantic segmentation to identify the one or more indicative areas of the input image.

6. The method of claim 1, wherein at least one of the image segmentation model and the convolutional model are trained using labeled images illustrating the specific object.

7. The method of claim 6, wherein the labeled images include both a label and a confidence score associated with the label.

8. A computing system for detecting an object in an image, the computing system comprising:
one or more electronic processors; and
a non-transitory, computer-readable medium comprising:
an image segmentation model;
a convolutional model; and
one or more instructions that, when executed by the one or more electronic processors, cause the one or more electronic processors to perform a process, the process comprising:
receiving an input image;
analyzing, by the at least one electronic processor, the input image using an image segmentation model to identify one or more indicative areas within the input image, the one or more indicative areas being indicative of one or more objects within the input image;
analyzing, by the one or more electronic processors, the one or more indicative areas of the input image using a convolutional model to generate at least one label for at least one portion of the one or more indicative areas of the input image, the label indicating whether a specific object is identified within the input image; and
performing, by the one or more electronic processors, at least one action based on the at least one label for the at least one portion.

9. The computing system of claim 8, wherein the one or more indicative areas of the input image are represented by a grayscale image illustrating the one or more indicative areas in the input image.

10. The computing system of claim 9, wherein the output of the image segmentation model is the grayscale image.

11. The computing system of claim 8, wherein the image segmentation model processes the input image at multiple resolution levels to identify the one or more indicative areas of the input image.

12. The computing system of claim 11, wherein outputs of the multiple resolution levels are aggregated by the image segmentation model to perform semantic segmentation to identify the one or more indicative areas of the input image.

13. The computing system of claim 8, wherein at least one of the image segmentation model and the convolutional model are trained using labeled images illustrating the specific object.

14. The computing system of claim 13, wherein the labeled images include both a label and a confidence score associated with the label.

15. A non-transitory, computer-readable medium comprising:
an image segmentation model;
a convolutional model; and
one or more instructions that, when executed by one or more electronic processors, cause the one or more electronic processors to perform a process, the process comprising:
receiving an input image;
analyzing the input image using an image segmentation model to identify one or more indicative areas within the input image, the one or more indicative areas being indicative of one or more objects within the input image;
analyzing the one or more indicative areas of the input image using a convolutional model to generate at least one label for at least one portion of the one or more indicative areas of the input image, the label indicating whether a specific object is identified within the input image; and
performing at least one action based on the at least one label for the at least one portion.

16. The non-transitory, computer-readable medium of claim 15, wherein the one or more indicative areas of the input image are represented by a grayscale image illustrating one or more indicative areas in the input image.

17. The non-transitory, computer-readable medium of claim 16, wherein the output of the image segmentation model is the grayscale image.

18. The non-transitory, computer-readable medium of claim 15, wherein the image segmentation model processes the input image at multiple resolution levels to identify the one or more indicative areas of the input image.

19. The non-transitory, computer-readable medium of claim 18, wherein outputs of the multiple resolution levels are aggregated by the image segmentation model to perform semantic segmentation to identify the one or more indicative images of the input image.

20. The non-transitory, computer-readable medium of claim 15, wherein at least one of the image segmentation model and the convolutional model are trained using labeled images illustrating the specific object.
